(19) United States
(12) Patent Application Publication
(10) Pub. No.: US 2007/0286264 A1
(43) Pub. Date: Dec. 13, 2007

(54) Interference reduction in spread spectrum receivers

(75) Inventors: Ilkka Kontola, Julkujarvi (FI); Ville Eerola, Hameenlinna (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/449,572

(22) Filed: Jun. 7, 2006

(51) Int. Cl. H04B 1/00; H04L 27/06

(52) U.S. Cl. 375/152; 375/343

(57) ABSTRACT

The specification and drawings present a new method, system, apparatus and software product for reducing a narrowband or continuous wave (CW) interference of weak radio frequency signals (e.g., code modulated) in the spread spectrum receivers. A tuneable digital band-reject filter can be placed inside of a receiving and processing module in a processing phase where, e.g., the word-length is large but before any rate-change operation that is causing aliasing. The tuneable digital band-reject filter can be placed after performing a pre-selected matched filtering of the digital signal (the digital signal is typically generated by an RF front end), before further processing involving the rate-change operation.

### TECHNICAL FIELD

This invention generally relates to spread spectrum receivers, and more specifically to reducing a narrowband or continuous wave (CW) interference of weak radio frequency signals in the spread spectrum receivers.

### BACKGROUND ART

GNSS (global navigation satellite system) receivers determine their position by making accurate range measurements to transmitting satellites. However, the signals from GNSS satellites are always weak. Outdoors, with no obstructions, the signals are at least 10 dB below the total (thermal) noise power over the minimum necessary bandwidth. Indoors, the satellite signal can be 40 dB below the thermal noise level. For example, in GPS (global positioning system) the spreading codes are quite short and thus do not provide more than about 23-30 dB attenuation of CW (continuous wave) or narrowband interference, which may not be enough for the indoor applications.

Especially, acquisition of weak GNSS signals is very vulnerable to CW or narrowband interferences such as leaking harmonics of clock signals used in digital equipment. The CW-vulnerability of GNSS acquisition is due to the fact that in acquisition, all possible spreading code delays (thousands) and a number of possible frequencies (tens) have to be examined. The large number of possible code delay/frequency shift combinations will increase the probability of a false alarm. On the other hand, the sampling rate changes implied in correlation process, and examining many frequencies practically always result in aliasing of any CW/narrowband interference into at least one of the examined frequencies.

As a remedy for reducing the CW or narrowband interferences, tuneable analog band-reject is not a preferred option due to an increased demand for digitalization of the whole circuitry. Digital band-reject filters placed between an ADC (analog-to-digital converter) and acquisition hardware would be effective only if the ADC would have at least 8 to 12 bits. Most GPS receivers today are using only 1 to 3 bit ADCs. Having more bits in the ADCs would make the receiver more expensive. At least in typical civil signal GPS receivers, both tuneable analog and digital band-reject filters seem to be rejected as being too costly.

### DISCLOSURE OF THE INVENTION

According to a first aspect of the invention, a method, comprises: receiving a radio frequency signal comprising a narrowband or continuous wave interference component by a receiver and converting the radio frequency signal to a digital signal; performing a pre-selected matched filtering of the digital signal for providing a matched filter signal; and digital filtering the matched filter signal to reduce the narrowband or continuous wave interference component before further processing in the receiver.

According further to the first aspect of the invention, a word-length of the digital signal may be smaller than a word length of the matched filter signal.

According further to the first aspect of the invention, the digital filtering may be performed by a tuneable band-rejection filtering block. Further, the tuneable band-rejection filtering block may comprise a spectral peak finding and coefficient block configured to determine filter coefficients for a desired band rejection, and a band rejection filter which uses the filter coefficients for the digital filtering. Further still, the spectral peak finding and coefficient block may be configured to determine the filter coefficients peak finding using a fast Fourier transformation.

Still further according to the first aspect of the invention, the further processing may comprise a discrete Fourier transformation. Further, the matched filter signal after the digital filtering may be stored using demultiplexing before further processing using the discrete Fourier transformation.

According further to the first aspect of the invention, the radio frequency signal may be a code division multiple access signal.

According still further to the first aspect of the invention, the pre-selected matched filtering may be performed by a matched filter which is a finite impulse response filter with tap coefficients equal to chip values of a replica spreading code provided to the matched filter.

According further still to the first aspect of the invention, the further processing may use a rate-change operation.

According yet further still to the first aspect of the invention, the receiver may be a spread spectrum receiver.

According to a second aspect of the invention, a computer program product comprises: a computer readable storage structure embodying computer program code thereon for execution by a computer processor with the computer program code, wherein the computer program code comprises instructions for performing the method of the invention according to the first aspect of the invention.

According to a third aspect of the invention, an apparatus, comprises: an antenna, responsive to a radio frequency signal comprising a narrowband or continuous wave interference component, for converting the radio frequency signal to a radio frequency electrical signal; an RF front end, responsive to the radio frequency electrical signal, configured to provide a digital signal; and a receiving and processing module, configured to perform a pre-selected matched filtering of the digital signal for providing a matched filter signal and further configured to digitally filter the matched filter signal to reduce the narrowband or continuous wave (CW) interference component before further processing in the apparatus.

Further according to the third aspect of the invention, a word-length of the digital signal may be smaller than a word length of the matched filter signal.

Still further according to the third aspect of the invention, the receiving and processing module may comprise a tuneable band-rejection filtering block configured to perform the digital filtering. Further, the tuneable band-rejection filtering block may comprise a spectral peak finding and coefficient block configured to determine filter coefficients for a desired band rejection, and a band-rejection filter configured to use the filter coefficients for the digital filtering.

According further to the third aspect of the invention, the further processing may comprise a discrete Fourier transformation (DFT). Further, the receiving and processing module may comprise a demultiplexer configured to store the matched filter signal after the digital filtering before further processing using the discrete Fourier transformation (DFT).

According still further to the third aspect of the invention, the radio frequency signal may be a code division multiple access (CDMA) signal.

According yet further still to the third aspect of the invention, the apparatus may be a receiver, a spread spectrum receiver, a global navigation satellite system (GNSS) receiver, a global positioning system receiver or a Galileo receiver.

According further still to the third aspect of the invention, the matched filter may be a finite impulse response filter with tap coefficients equal to chip values of a replica spreading code provided to the matched filter.

According to a fourth aspect of the invention, a system, comprises: a satellite, for providing a radio frequency signal; a base station, for providing a further radio frequency signal used for mobile communications; and a terminal, responsive to the radio frequency signal or to the further radio frequency signal, both containing a narrowband or continuous wave (CW) interference component, wherein the terminal comprises a receiver, which is adapted to:
receive a radio frequency signal comprising a narrowband or continuous wave interference component by a receiver and converting the radio frequency signal to a digital signal;
perform a pre-selected matched filtering of the digital signal for providing a matched filter signal; and
digitally filter the matched filter signal to reduce the narrowband or continuous wave interference component before further processing in the receiver.

According further to the fourth aspect of the invention, the receiver may be a spread spectrum receiver.

According to a fifth aspect of the invention, an apparatus, comprises: means for receiving a radio frequency signal comprising a narrowband or continuous wave interference component and converting the radio frequency signal to a digital signal; means for performing a pre-selected matched filtering of the digital signal for providing a matched filter signal; and means for digital filtering the matched filter signal to reduce the narrowband or continuous wave interference component before further processing in the apparatus.

According further to the fifth aspect of the invention, the apparatus may be a receiver, a spread spectrum receiver, a global navigation satellite system (GNSS) receiver, a global positioning system receiver or a Galileo receiver.

### BRIEF DESCRIPTION OF THE DRAWINGS

For a better understanding of the nature and objects of the present invention, reference is made to the following detailed description taken in conjunction with the following drawings, in which:

FIG. 1 is a block diagram representing an example of a global navigation satellite system receiver (spread spectrum receiver);

FIG. 2 is a block diagram representing an example of a spread spectrum receiver with a tuneable band-rejection filtering block for reducing narrowband or continuous wave (CW) interference, according to an embodiment of the present invention;

FIG. 3 is a block diagram representing an example of a detailed implementation of a receiving and processing module of the spread spectrum receiver with a tuneable band-rejection filtering block for reducing narrowband or continuous wave (CW) interference, according to an embodiment of the present invention; and

FIG. 4 is a diagram showing an example of a terminal with a spread spectrum receiver adapted to reducing narrowband or continuous wave (CW) interference for processing radio frequency signals from satellites and/or base stations.

### MODES FOR CARRYING OUT THE INVENTION

A new method, system, apparatus, system and software product are presented for reducing a narrowband or continuous wave (CW) interference of weak radio frequency signals (e.g., code modulated) in the spread spectrum receivers. According to an embodiment of the present invention, a tuneable digital band-reject filter (or a tuneable band-rejection filtering block) can be placed inside of a receiving and processing module in a processing phase where, e.g., the word-length is large but before any rate-change operation that is causing aliasing. Thus the band-reject filter does not significantly increase the complexity and cost of the acquisition hardware/software of the spread spectrum receivers.

For example, according to an embodiment of the present invention, the tuneable digital band-reject filter can be placed after performing a pre-selected matched filtering of the digital signal before further processing involving the rate-change operation, wherein the digital signal is typically generated by a preprocessor. Typically the word-length of the digital signal generated by the preprocessor (e.g., by an analog-to-digital converter) is much smaller than a word length of the matched filter output.

Moreover, according to further embodiment of the present invention, the digital filtering can be performed by a band-rejection filtering block, comprising, e.g., a spectral peak finding and coefficient block configured to detect the frequencies of the CW interference signals and to determine filter coefficients for a desired band rejection (e.g., using a fast Fourier transformation, FFT), and a filter which uses the determined filter coefficients for the digital filtering. There could be several band-reject filters for simultaneously attenuating more than one interference. The band-rejection filter could also be a multi-band filter. Furthermore, the further processing can comprise the discrete Fourier transformation (DFT), matched filter output signal filtered by the tuneable band-rejection filterer is stored in a matrix before further performing the DFT for each code delay.

The matched filter can be a FIR (finite impulse response filter) having (time-reversed) replica code as the tap coefficients or a system that uses FFT/DFT to perform a convolution operation.

It is further noted that in the frame of the present invention, the radio frequency signal is typically a code modulated signal using, e.g., a code division multiple access (CDMA) modulation format. The spread spectrum receiver can be (but is not limited to) a global navigation satellite system (GNSS) receiver, a global positioning system receiver, a Galileo receiver, GLONASS, etc. Also, the invention can be applied in a broader sense to any communication system utilizing spread spectrum receivers. It can be applied to mobile phones, e.g., utilizing code-division multiple access (CDMA) or wideband CDMA (WCDMA), where it can be used, for example, for network positioning, where the mobile phone measures ranges to base stations. As the invention generally relates to improving CW or narrowband interference resistance of acquisition of very weak GNSS signals, it can be especially effective in the spread spectrum receivers using DFT-based coherent integration after a matched filter.

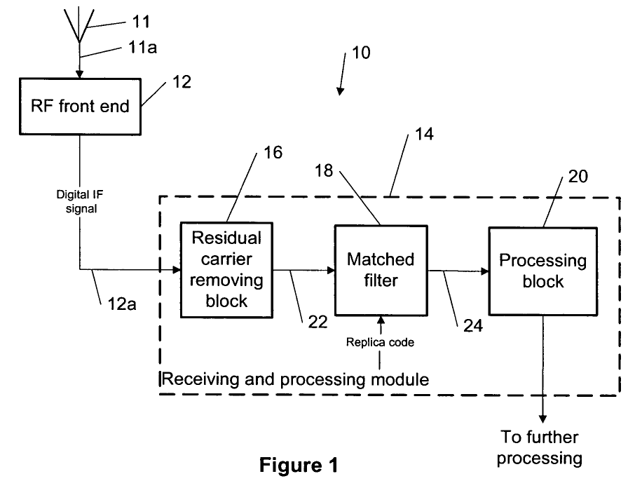

FIG. 1 is a block diagram representing one example, among others, of a typical operation of a spread spectrum receiver 10 wherein the present invention can be applied. The receiver 10 can be a GNSS (global navigation satellite system) receiver, a GPS (global positioning system) receiver, a Galileo receiver, or any other compatible receiver presently available or a subject of future technological advances, according to embodiments of the present invention.

A typical receiver operation includes receiving the radio frequency signal and converting said radio frequency signal containing a narrowband or continuous wave (CW) interference component to a radio frequency electrical signal 11a by an antenna 11 followed by converting said radio frequency electrical signal 11a to a digital intermediate frequency (IF) signal (or a digital signal) 12a by an RF front end 12 (typically, the signal 12a is an output of the analog-to-digital converter) and providing said digital signal 12a to a receiving and processing module 14. The block 14 can comprise a residual carrier removing block 16, a matched filter 18 and a processing block 20. Typically the word-length of the digital signal 12a or a data signal 22 (after removing intermediate frequency by the block 16) is much smaller than a word length of the matched filter signal 24 provided by the block 18. The blocks 16, 18 and 20 can be implemented in a variety of ways but are well known in the art.

For example, the matched filter 18 can be a FIR (finite impulse response) filter in which the “tap” coefficients are the chip values of the replica spreading code provided to the matched filter 18. As any constant-tap FIR filter, the matched filter 18 is a linear (and also time-invariant) system and thus it does not change any other properties than amplitude and phase of any CW (or narrowband) signal going in. Thus the CW (or narrowband) signal is only attenuated and phase-shifted by the matched filter 18. The attenuation is a desired phenomenon which can be further improved according to further embodiments of the present invention.

If there is a CW or narrowband interference signal present in the signal 24 at the output of the block 18, it can be further attenuated by a tuneable digital band-reject filter. The benefit of placing the band-reject filter after the block 18 is the fact that there is no need to increase the world-length of the existing design.

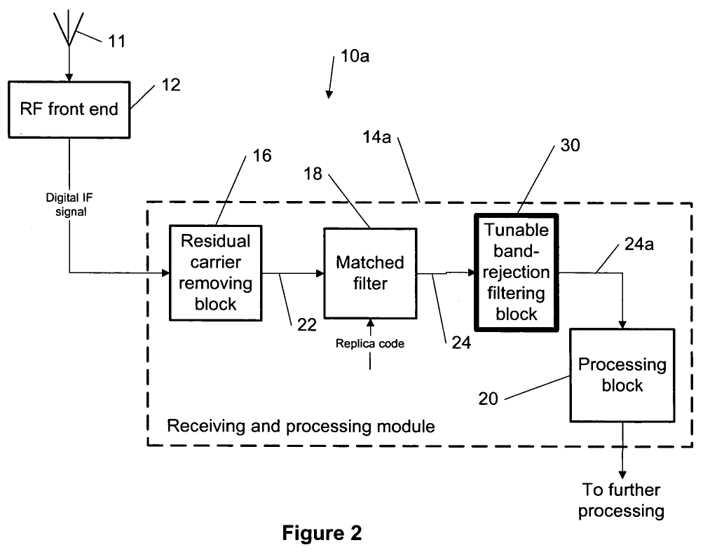

FIG. 2 is one example among others of a block diagram of spread spectrum receiver 10 (e.g., the GSNN receiver) with a tuneable band-rejection filtering block 30 (e.g., containing a band-rejection filter) for reducing narrowband or continuous wave (CW) interference, according to an embodiment of the present invention. The filter block 30 is inserted between the blocks 18 and 20 in the receiving and processing module 14a, as discussed above according to an embodiment of the present invention, and generates the filtered matched filter signal 24a.

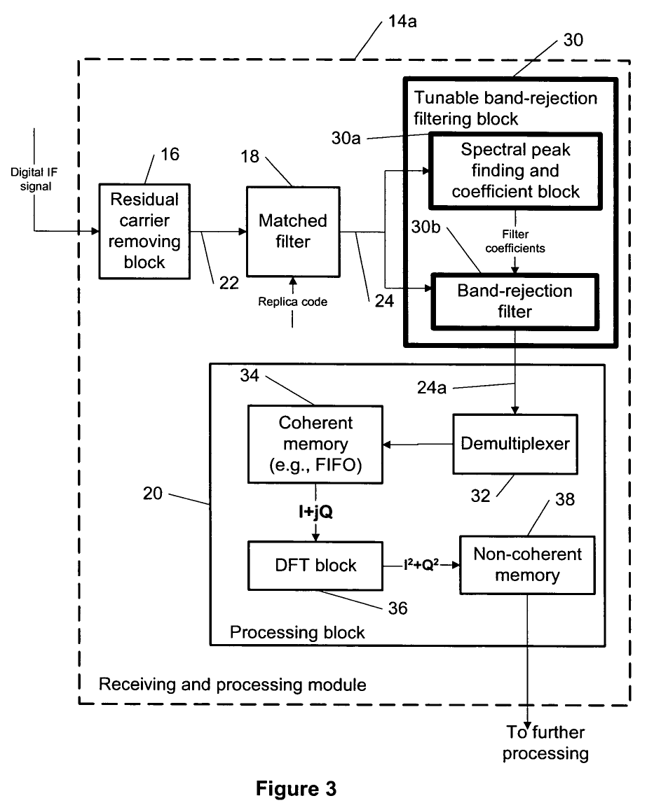

FIG. 3 is a block diagram representing an example among others of a detailed implementation of the receiving and processing module 14a of the spread spectrum receiver 10a with a tuneable band-rejection filters for reducing narrowband or continuous wave (CW) interference, according to an embodiment of the present invention. The tuneable band-rejection filtering block 30 can comprise a spectral peak finding and coefficient block 30a configured to determine filter coefficients (e.g., using a fast Fourier transformation, FFT) for a desired band rejection and thus providing the tunability mechanism, and a band rejection filter 30b which uses the determined filter coefficients for the digital filtering. It is noted that it can be several band-reject filters for attenuating simultaneously more than one interference. The band-rejection filter could also be a multi-band filter. In an FFT-based matched filter implementation, the band-reject filter can be realized as selective nulling of certain frequency bins before the inverse FFT operation.

If the interference frequency is far from the residual frequency error (e.g., due to unknown Doppler shift and reference oscillator bias) of the satellite signal, the band-rejection filter 30b will attenuate the interference without affecting the wanted signal. The chances for that are quite good because the acquisition engine is most vulnerable to CW/narrowband signals within about +/−700 kHz range from the nominal satellite frequency and the band examined for the satellite signals is only a few kilohertz.

According to an embodiment of the present invention, the block 30, 30a or 30b can be implemented as a software or a hardware block or a combination thereof. Furthermore, the block 30, 30a or 30b can be implemented as a separate block or can be combined with any other standard block of the spread spectrum receiver 10 or it can be split into several blocks according to their functionality.

FIG. 3 further demonstrates possible implementation details of the processing block 20. A demultiplexer 32 after the matched filter 18 (implemented, e.g., as a FIR) is used for storing in the coherent memory 34 the results according to the corresponding delay in both inphase I and quadrature Q branches (e.g., filled as first in/first out columns). These results (I+jQ) are further processed by a DFT (discrete Fourier transformation) block 36 generating results (I²+Q²) stored in the non-coherent memory 38 for further processing.

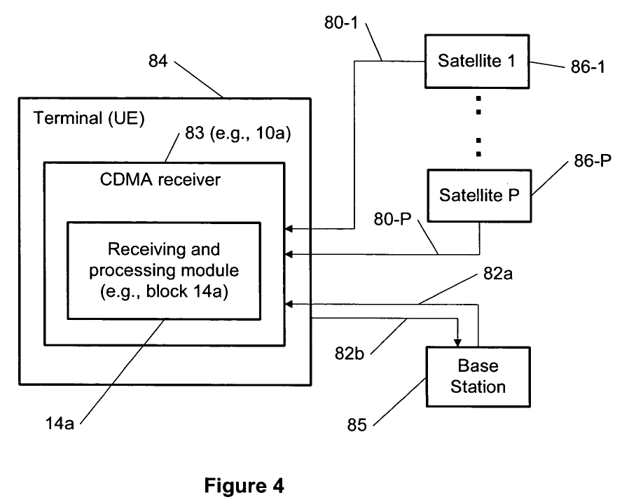

The present invention can be applied to a variety of applications and not only to the GPS and Galileo satellite navigation systems. The invention can be used equally well with other navigation systems or more generally with any communication systems utilizing a spread spectrum receiver. An example of such a system is shown in FIG. 4. A terminal (or a user equipment, UE) 84 is a communication device, such as a mobile device or a mobile phone, containing, e.g., a CDMA receiver 83 according to the present invention. The CDMA receiver 83 can be, for instance, the spread spectrum (GNSS) receiver 10a described in the examples of FIGS. 2 and 3. Moreover, the CDMA receiver 83 contains the receiving and processing module 14a with the knovel tuneable band-rejection filtering block 30, as described above. The block 14a can be built as a removable unit. FIG. 7 shows P satellites 86-1, . . . , 86-P sending P satellite signals 80-1, . . . , 80-P, to the CDMA spread spectrum receiver 83. FIG. 4 also shows a base station 85, which communicates with the terminal 84 by sending, e.g., a mobile CDMA communication signal 82a to the CDMA spread spectrum receiver 83 and receiving back the outgoing communication signal 82b from the terminal 84. The signals 80-1, . . . , 80-P and 82a can contain the narrowband or continuous wave (CW) interference component and are processed by the receiving and processing module 14a as described in the embodiments of the present invention.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
receiving a radio frequency signal comprising a narrowband or continuous wave interference component by a receiver and converting said radio frequency signal to a digital signal;
performing a pre-selected matched filtering of said digital signal for providing a matched filter signal; and
digital filtering said matched filter signal to reduce said narrowband or continuous wave interference component before further processing in said receiver.

2. The method of claim 1, wherein a word-length of said digital signal is smaller than a word length of the matched filter signal.

3. The method of claim 1, wherein said digital filtering is performed by a tuneable band-rejection filtering block.

4. The method of claim 3, wherein said tuneable band-rejection filtering block comprises a spectral peak finding and coefficient block configured to determine filter coefficients for a desired band rejection, and a band rejection filter which uses said filter coefficients for said digital filtering.

5. The method of claim 4, wherein said spectral peak finding and coefficient block is configured to determine said filter coefficients peak finding using a fast Fourier transformation.

6. The method of claim 1, wherein said further processing comprises a discrete Fourier transformation.

7. The method of claim 6, wherein said matched filter signal after said digital filtering is stored using demultiplexing before further processing using said discrete Fourier transformation.

8. The method of claim 1, wherein said radio frequency signal is a code division multiple access signal.

9. The method of claim 1, wherein said pre-selected matched filtering is performed by a matched filter which is a finite impulse response filter with tap coefficients equal to chip values of a replica spreading code provided to said matched filter.

10. The method of claim 1, wherein said further processing uses a rate-change operation.

11. The system of claim 1, wherein said receiver is a spread spectrum receiver.

12. A computer program product comprising: a computer readable storage structure embodying computer program code thereon for execution by a computer processor with said computer program code, wherein said computer program code comprises instructions for performing the method of claim 1.

13. An apparatus, comprising:
an antenna, responsive to a radio frequency signal comprising a narrowband or continuous wave interference component, for converting said radio frequency signal to a radio frequency electrical signal;
an RF front end, responsive to the radio frequency electrical signal, configured to provide a digital signal; and
a receiving and processing module, configured to perform a pre-selected matched filtering of said digital signal for providing a matched filter signal and further configured to digitally filter said matched filter signal to reduce said narrowband or continuous wave interference component before further processing in said apparatus.

14. The apparatus of claim 13, wherein a word-length of said digital signal is smaller than a word length of the matched filter signal.

15. The apparatus of claim 13, wherein said receiving and processing module comprises a tuneable band-rejection filtering block configured to perform said digital filtering.

16. The apparatus of claim 15, wherein said tuneable band-rejection filtering block comprises a spectral peak finding and coefficient block configured to determine filter coefficients for a desired band rejection, and a band-rejection filter configured to use said filter coefficients for said digital filtering.

17. The apparatus of claim 13, wherein said further processing comprises a discrete Fourier transformation.

18. The apparatus of claim 17, wherein said receiving and processing module comprises a demultiplexer configured to store said matched filter signal after said digital filtering before further processing using said discrete Fourier transformation (DFT).

19. The apparatus of claim 13, wherein said radio frequency signal is a code division multiple access signal.

20. The apparatus of claim 13, wherein said apparatus is a receiver, a spread spectrum receiver, a global navigation satellite system receiver, a global positioning system receiver or a Galileo receiver.

21. The apparatus of claim 13, wherein said matched filter is a finite impulse response filter with tap coefficients equal to chip values of a replica spreading code provided to said matched filter.

22. A system, comprising:
a satellite, for providing a radio frequency signal;
a base station, for providing a further radio frequency signal used for mobile communications; and
a terminal, responsive to said radio frequency signal or to said further radio frequency signal, both containing a narrowband or continuous wave interference component, wherein said terminal comprises a receiver, which is adapted to:
receive a radio frequency signal comprising a narrowband or continuous wave interference component by a receiver and converting said radio frequency signal to a digital signal;
perform a pre-selected matched filtering of said digital signal for providing a matched filter signal; and
digitally filter said matched filter signal to reduce said narrowband or continuous wave interference component before further processing in said receiver.

23. The system of claim 22, wherein said receiver is a spread spectrum receiver.

24. An apparatus, comprising:
means for receiving a radio frequency signal comprising a narrowband or continuous wave interference component and converting said radio frequency signal to a digital signal;
means for performing a pre-selected matched filtering of said digital signal for providing a matched filter signal; and
means for digital filtering said matched filter signal to reduce said narrowband or continuous wave interference component before further processing in said apparatus.

25. The apparatus of claim 24, wherein said apparatus is a receiver, a spread spectrum receiver, a global navigation satellite system receiver, a global positioning system receiver or a Galileo receiver.
